(19) United States
(12) Patent Application Publication
(10) Pub. No.: US 2002/0094473 A1
(43) Pub. Date: Jul. 18, 2002

(54) Venting casing for a battery

(76) Inventor: Ching-Yuan Lin, Taichung (TW)

Correspondence Address: THORP REED & ARMSTRONG, LLP, ONE OXFORD CENTRE, 301 GRANT STREET, 14TH FLOOR, PITTSBURGH, PA, 15219-1425, US

(21) Appl. No.: 09/761,614

(22) Filed: Jan. 16, 2001

(51) Int. Cl. H01M 2/12

(52) U.S. Cl. 429/86; 429/87; 429/175

(57) ABSTRACT

A venting casing with plugs for a battery includes a base defining lead chambers with acid contained therein, a cover fitted to the base, and plugs fitted in the cover. Each plug has a passage communicating an interior of the base with the atmosphere. A valve cap fitted in each plug regulates flow of vapors emitted from the lead chambers to the atmosphere, and a filter purifies the vapors. Each filter has an upper surface protected by a disc.

### BACKGROUND OF THE INVENTION

1. Field of the Invention

The present invention is related to a venting casing for a battery, and more particularly, a venting casing with plugs for a battery which allows waste product vapors to disperse safely and effectively from within the battery, and wherein filters in the plugs can, be easily removed for replacement and maintenance of the battery.

2. Description of Related Art

Batteries, such as those for starting internal combustion engines, contain acid-bearing lead cells to produce electricity. During the process for producing the electricity, acid is transformed to vapor which in turn is vented from the cells to the atmosphere.

Referring to FIG. 5, a prior art battery includes a base (30) with a plurality of lead cells containing acid, and a cover (40) fitted to a top of the base (30). A trench is formed in a top surface of the base (30) and has two outer walls (41) and two inner walls (42) formed between the outer walls (41). The inner walls (42) surround an opening (420) in communication with the lead cells. A cap (50) is fitted in the trench such that a top face of the cap (50) is flush with the top surface of the cover (40), and secured thereby an ultrasonic welding method. The cap (50) includes two legs (51) extending downward therefrom and which abut an inner bottom of the trench and surround the inner walls (42). Small passages are defined among the inner walls (42), the legs (51) and the outer walls (41), whereby vapors as indicated by the arrows, are vented from the lead cells to the atmosphere. However, the first prior art battery has the following drawbacks:

(i) The passages are so small that they are easily blocked by dirt and dust, whereby the vapors cannot be vented properly and the battery ultimately becomes defective;

(ii) The acid in the battery cannot be maintained due the welding of the cover to the base; and

(iii) The vapors are not filtered and so the atmosphere is contaminated.

A second prior art battery is shown in FIGS. 6 and 7, and contains a base (30), a cover (60), and a plurality of caps (70) fitted to the cover (60) by ultrasonic welding. The base (30) has a plurality of partitions (31) to define outer and central lead chambers containing acid. Some of the partitions (31) have a slot (310) intended to allow equalization of pressure of vapors emitted from the chambers. The cover (60) has a plurality of outlets (61) substantially corresponding to the chambers, and two vents (62). The outlets (61) each have a chimney communicating with the chambers, and the vents (62) each have an exit with a porous filter (63) at a top end thereof. A plate (64) protects top surfaces of the filters (63). The caps (70) have sockets (71) extending downward therefrom and sized to be respectively received in the outlets (61). Passages are defined between the outlets (61) and the sockets (71) whereby, as shown by the arrows in FIG. 7, vapors (A) should travel from the chambers to the filter (63) via the passages of the outlets (61) and the vents (62), and to the atmosphere via gaps, defined between the plates (64) and the caps (70). However, this second prior art battery has the following drawbacks:

(iv) It is found again that that passages become narrow or blocked by dust and dirt, and the vapors (A) flow via the slots (310) into the central lead chamber due to lower pressure as a result of the exit. The extra direct flow of the vapors (A) to the exit leads to a build up of the vapors (A), and this in turn returns to their liquid state whereby the acid level of the central chamber is much higher than the outer chambers. This excess leads to premature failure of the battery; and

(v) The welding of the caps to the cover means that maintenance cannot be carried out easily on the acid of the battery.

Thus, there is a long and unfulfilled need for a venting casing for a battery by which waste product vapors can be safely and effectively dispersed from the battery, and by which filters can easily be replaced, as well as maintenance of acid in the battery being possible.

### SUMMARY OF THE INVENTION

An objective of the present invention is to provide a venting casing for a battery by which waste product vapors can be safely dispersed from chambers of the battery.

A further objective of the present invention is to provide a venting casing with plugs for a battery by which waste product vapors can be evenly-dispersed from chambers of the battery.

A further objective of the present invention is to provide a venting casing with plugs for a battery by which the chambers of the battery are easily accessed by removal of filters of the plugs, whereby maintenance can be carried out on the battery.

A further objective of the present invention is to provide a venting casing with plugs for a battery in which filters are easily replaced.

A venting casing with plugs for a battery in accordance with the present invention comprises a battery base, a battery cover fitted to the base, and a plurality of plugs received in the cover. The base has a plurality of lead chambers containing acid, and during operation, vapors are given off from the acid. Each plug has a passage extending from a bottom face to a top face. The passage includes a valve cap which regulates flow of the vapors, a filter which purifies the vapors, and a disc which protects the filter. The disc, filter and valve cap can be removed easily from each plug to enable easy replacement thereof and simple maintenance of the battery.

Other objects, advantages and novel features of the invention will become more apparent from the following detailed description when taken in conjunction with the accompanying drawings.

### BRIEF DESCRIPTION OF THE DRAWINGS

FIG. 1 is an exploded view of a venting casing with plugs for a battery in accordance with the present invention;

FIG. 2 is a cross-sectional view of the plug of the venting casing shown in FIG. 1;

FIG. 3 is a schematic view of the plug of FIG. 2;

FIG. 4 is a cross-sectional view of a second embodiment of the plug of FIG. 2;

FIG. 5 is a cross-sectional view of part of a first prior art battery casing;

FIG. 6 is an exploded view of a second prior art battery casing; and

FIG. 7 is a cross-sectional view of part of the second prior art battery casing shown in FIG. 6.

### DETAILED DESCRIPTION OF THE PREFERRED EMBODIMENT

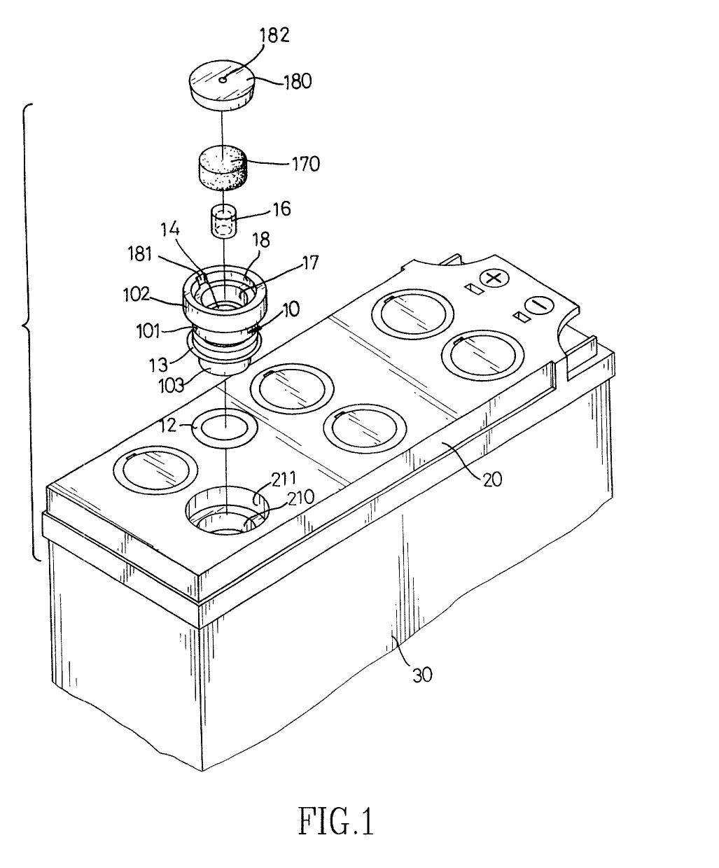

As shown in the figures and in particular FIGS. 1 and 3, a venting casing for a battery in accordance with the present invention comprises a plurality of plugs (10), a battery cover (20) and a battery base (30).

The base (30) defines a plurality of lead chambers which are filled with an electrolyte such as acid to produce an electric charge. However, the process for producing the charge itself does not form part of the claimed invention and thus further description thereof is omitted.

The cover (20) is fitted hermetically at distal edges thereof to a top of the base (30), by a conventional method such as ultrasonic welding. A plurality of identical outlets corresponding to the plurality of lead chambers is defined in the cover (20), to communicate top and bottom faces of the cover (20). Each outlet has a lower bore (210) leading to an upper counter bore (211), and a shoulder (214) formed between the lower bore (210) and the upper counter bore (211). The outlet further has a bottom edge (216) and a top edge (218).

As the plugs (10) are identical, reference thereto hereinafter is in the singular. The plug (10) has a hollow central body (101) with a flange (102) formed at a top end thereof and a boss (103) formed at a bottom thereof. The flange (102) and the boss (103) respectively have diameters larger and smaller than a diameter of the central body (101). An O-ring groove (105) is defined in an outer periphery of the central body (101), and receives therein an O-ring (12) which protrudes from the O-ring groove (105). A resilient circumferential lip (13) extends around a bottom of the central body (101) and has a beveled lower edge and a flat upper edge. Each plug (10) further has a passage extending between a top face and a bottom face and sequentially defined by a top counter bore (18), a bore (17), a recess (14) surrounding a tubular projection (15), a longitudinal orifice (150) defined in the tubular projection (15), and a bottom counter bore (152). A first step (184) is formed between the top counter bore (18) and the bore (17), and a second step (174) is formed between the bore (17) and the recess (14). The top counter bore (18) is tapered inward towards the first step (184), and a notch (9) is longitudinally defined in a side wall defining the top counter bore (18). A top face of the tubular projection (15) is lower than the second step (174). A resilient valve cap (16) is mounted over the top face of the tubular projection (15). A filter (170) is received in the bore (17) and rests on the second step (174) such that a top face of the filter (170) is Hush with the first step (184). A disc (180) is received in the top counter bore (18) and covers the filter (170). The disc (180) has an egress (182) defined therethrough, a cavity (186) defined in an under face and in communication with the egress (182), and a tapered side wall corresponding to the taper of the top counter bore (18).

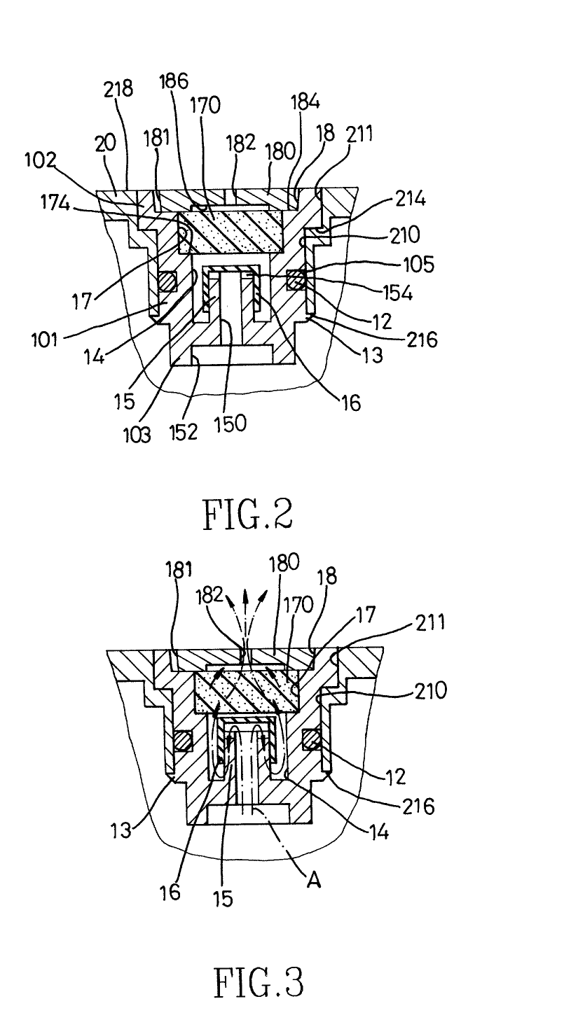

In assembly, referring to FIG. 2, the cover (20) is mounted on the base (30) and preferably retained there in a permanent manner by means such as ultrasonic welding. The plug (10) with the O-ring (12) received in the O-ring groove (105) is fitted with the corresponding outlet to provide a hermetic seal between the outer periphery of the plug (10) and the cover (20). As an operator pushes the plug (10) down the outlet, the lip (13) is deformed inward when travelling down the bore (17) until reaching the bottom edge of the outlet whereafter the lip (13) springs back to its original status and the plug (10) is securely engaged with the cover (20). The resilient valve cap (16) is fitted loosely over the tubular projection (15), and the filter (170) is rested on the second step (174) of the bore (17) of the plug (10). The disc (180) is placed in the top counter bore (18) with the under face of the disc (180) abutting the filter (170) and the first step (184). Alternatively, the plug (10) can be pre-assembled before being fitted in the cover (20), ie, the O-ring (12) is fitted in the O-ring groove (105), the resilient valve cap (16) is mounted over the tubular projection (15), the filter (17) is rested on the second step (174), the disc (180) is rested on the first step (184), and then the plug (10) is inserted in the outlet, boss (103) lowermost, until the upper flat edge of the resilient lip (13) engages with the bottom edge of the outlet.

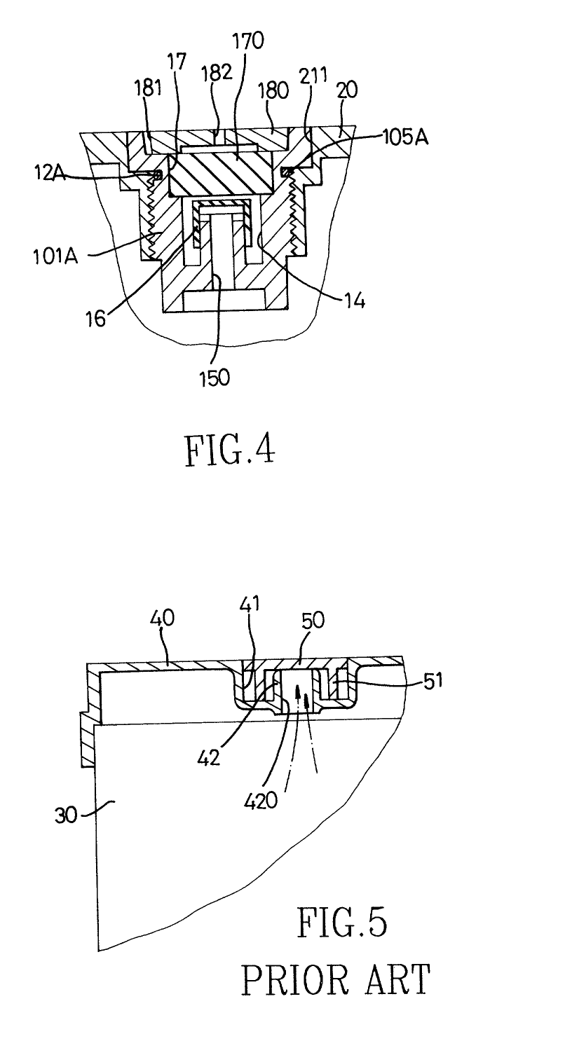

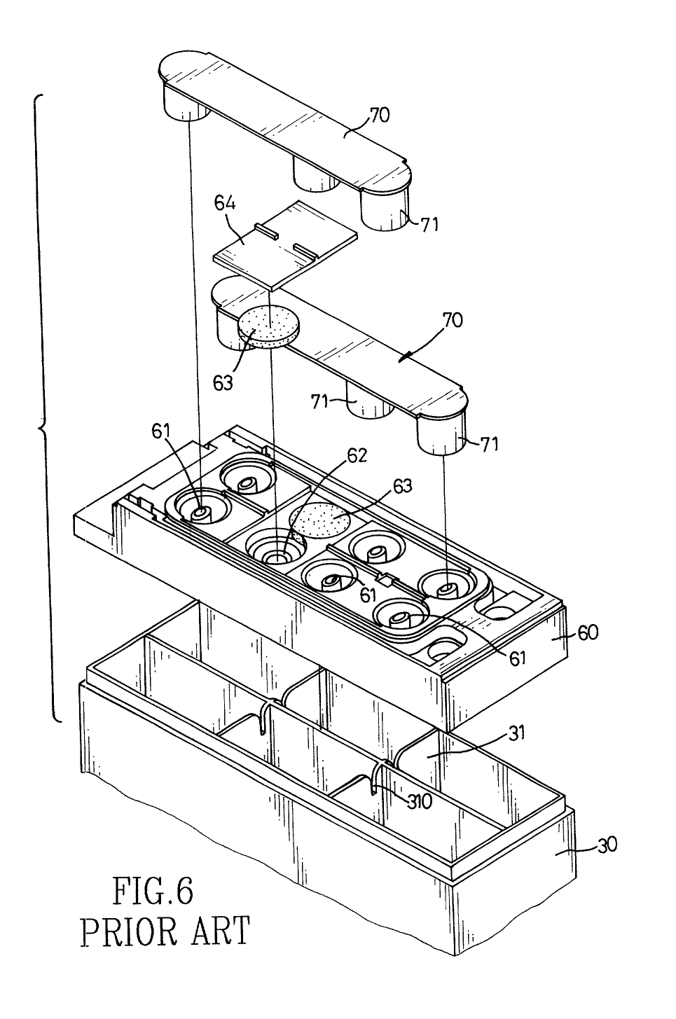

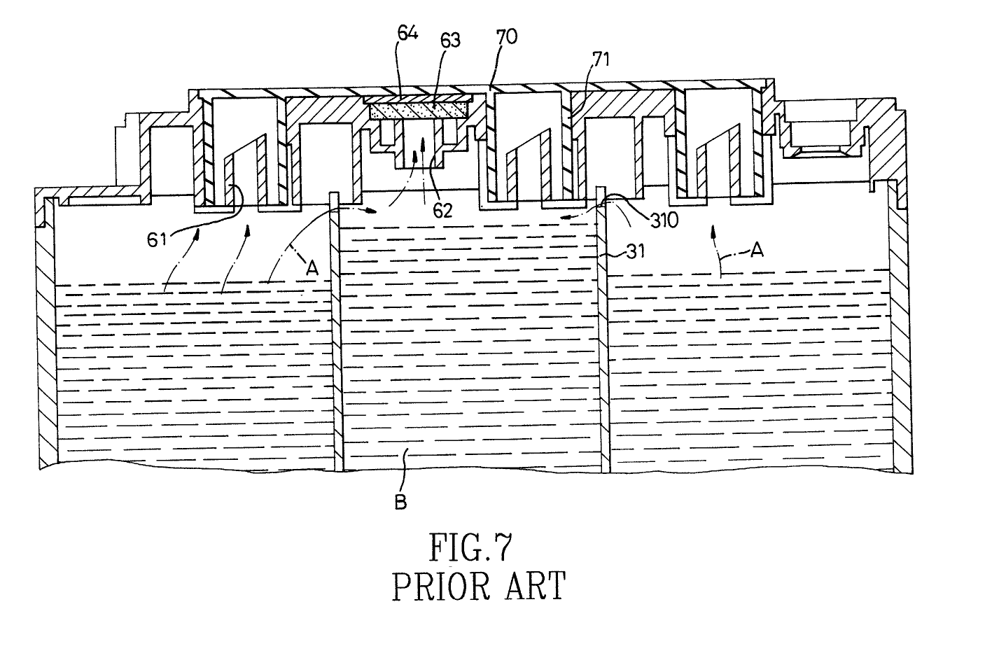

In operation, referring to FIG. 4, vapors (indicated by arrows) travel from the lead chambers to the cover (20) and sequentially pass along the bottom counter bore (152), the longitudinal orifice (150), the resilient valve cap (16), the recess (14), the filter (170), the cavity (186) and the egress (182) to enter the atmosphere. It is to be noted that the loose attachment and resiliency of the resilient valve cap (16) permit it to expand outward and rise up the tubular projection (15) to enable the vapor to pass down the interior of the resilient valve cap (16) and enter the recess (14).

In a second embodiment, the top face of the tubular projection (15) includes a transverse slot (154) in communication with the longitudinal orifice (150) to assist the vapor to expand the resilient valve cap (16) to enable good flow of the vapors from the longitudinal orifice (150) to the recess (14). In the second embodiment, the plug (10) comprises the bottom counter bore (152), the longitudinal orifice (150), and the tubular projection (15), the transverse slot (154) in the top face of the tubular projection (15), the resilient valve cap (16) mounted over the top face of the tubular projection (15), the filter (170) rested on the second step (174), the disc (130) rested on the first step (184), and the O-ring (12) received in the O-ring groove (105).

In a third embodiment, referring to FIG. 4, the central body (101A) of the plug (10) is threaded, the O-ring (12A) and O-ring groove (105A) are disposed at an outer junction between the flange (102) and the central body (101A), and a side wall defining the lower bore (210) of the cover (20) is threaded corresponding to the thread of the central body (101A). In the third embodiment, the plug (10) with the bottom counter bore (152), the longitudinal orifice (150), the tubular projection (15) with the transverse slot (154) in the top face thereof, the resilient valve cap (16) mounted over the top face of the tubular projection (15), the filter (170) rested on the second step (174), and the disc (180) rested on the first step (184) is threadedly engaged by its threaded periphery with the threaded side wall of the lower bore (210) of the cover (20).

The venting casing for a battery in accordance with the present invention has the following advantages:

(a) ease of use—The plugs are simply and non-permanently fitted to the cover;

(b) safety—The vapors from the lead cells are filtered and so the environment is protected;

(c) convenience—The filters are easily removed from the plugs due to the notch defined in each top counter bore, whereby they can be replaced;

(d) low cost—The easy replacement of the filters means the battery can have an extended operational life, instead of having to be discarded;

(e) reliability—Dust and dirt are very unlikely to enter and block the egresses, and even if this should occur, the discs can be easily removed for cleaning of the egresses; and

(f) good maintenance—The easy removal of the filters and the valve caps, and the longitudinal orifices enable the acid in the battery to be checked and maintained.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A venting casing for a battery, comprising a battery base with lead chambers containing an electrolyte, a battery cover fitted to the battery base, and plugs for venting vapors from the lead chambers to the atmosphere, wherein the casing comprises:
the battery base;
the battery cover mounted to a top of the battery base and defining a plurality of outlets extending between a top face of the battery cover and a bottom face of the battery cover, each outlet having an upper counter bore communicating with a lower bore;
a plurality of hollow plugs corresponding to the plurality of outlets and each hollow plug being retained in a respective one of the outlets by attachment means and seal means, each of the plugs comprising a passage extending between a top face of the hollow plug and a bottom face of the hollow plug to guide the vapors from the lead chambers to the atmosphere, a valve fitted in the passage and regulating flow of the vapors, a filter fitted in the passage and between the valve and the top face of the hollow plug, and a disc fitted in the passage and above the filter to protect the filter from damage, whereby the vapors flowing from each lead chamber are regulated and purified prior to venting to the atmosphere, and the filter is replaceable.

2. The venting casing for a battery as claimed in claim 1, wherein the attachment means comprises threaded engagement between a threaded inner periphery defining each outlet and a threaded outer periphery of each hollow plug.

3. The venting casing for a battery as claimed in claim 1, wherein the attachment means comprises a resilient lip formed on an outer periphery of each plug and engageable with the bottom face of the cover, whereby the lip is compressed when travelling down the lower bore of the outlet and returns to its non-compressed state when passing out of the lower bore.

4. The venting casing for a battery as claimed in claim 1, wherein the seal means is an O-ring sandwiched between an outer periphery of each plug and an inner periphery of each outlet, whereby the vapors cannot travel between the plug and the outlet to escape to the atmosphere.

5. The venting casing for a battery as claimed in claim 1, wherein the passage sequentially comprises a lower counter bore, a longitudinal orifice extending between the lower counter bore and an end face of a tubular projection, a recess surrounding the tubular projection, a bore and an upper counter bore.

6. The venting casing for a battery as claimed in claim 1, wherein each hollow plug further has a central body, a flange formed at a top of the central body, and a boss formed at a bottom of the central body, wherein the central body is matingly received in the lower bore of the outlet, and the flange is matingly received in the upper counter bore of the outlet.

7. The venting casing for a battery as claimed in claim 5, wherein the filter is received in the bore of the plug.

8. The venting casing for a battery as claimed in claim 5, wherein the disc is received in the upper counter bore and defines an egress forming part of the passage, and further defines a cavity in an under face thereof to communicate with the egress.

9. The venting casing for a battery as claimed in 5, wherein the valve is a resilient cap with an open end, a closed end and an interior defined between the open and closed ends, whereby the interior of the resilient cap slidingly receives the tubular projection, and a lower face of the filter prevents the resilient cap from dis-mounting the tubular projection.

10. The venting casing for a battery as claimed in claim 8, wherein the resilient cap sealingly embraces a distal end of the tubular projection when the vapors are not emitted from the lead chamber, and the resilient cap expands to define a space between the interior of the resilient cap and a periphery of the tubular projection when the vapors are emitted from the battery and travel up the longitudinal orifice to exert against the resilient cap.

11. The venting casing for a battery as claimed in claim 5, wherein the end face of the tubular projection defines a transverse slot in communication with the longitudinal orifice, whereby flow of the vapors is enhanced.

12. The venting casing for a battery as claimed in claim 7, wherein a notch is defined in a side wall defining the upper counter bore, whereby a tool may be inserted in the notch to remove the disc from the outlet.

13. The venting casing for a battery as claimed in claim 4, wherein the O-ring circumferentially protrudes from an O-ring groove defined in the plug and abuts a middle portion of a side wall defining the lower bore of the outlet.

14. The venting casing as claimed in claim 4, wherein the O-ring circumferentially protrudes from an O-ring groove defined in the plug and abuts a top portion of a side wall defining the lower bore of the outlet.

15. A venting casing for a battery emitting vapors from an interior thereof, comprising:
a battery base from which the vapors are emitted;
a battery cover securely attached to a top of the battery base, and having at least one outlet extending between a top face of the battery cover and a bottom face of the battery cover, the at least one outlet comprising a lower bore, an upper counter bore communicating with the lower bore, a shoulder formed between the lower bore and the upper counter bore, a notch defined in a side wall of the upper counter bore, and a rim formed at a bottom of the lower bore;
at least one plug corresponding to the at least one outlet and comprising a central body received in the upper counter bore of the outlet, a flange formed on a top of the central body and rested on the shoulder of the outlet, a boss formed on a bottom of the central body, an O-ring groove defined in an outer side wall of the central body, a peripheral resilient lip with an inclined under face, a flat top face and formed around a junction between the central body and the boss, the peripheral resilient lip having a diameter slightly larger than a diameter of the lower bore of the outlet and the flat top face abutting the peripheral rim of the outlet, a top counter bore defined in the flange, a bore defined below the top counter bore and in communication therewith, a first step formed at a junction between the bore and the top counter bore, a recess formed below the bore and in communication therewith, a second step formed at a junction between the recess and the bore, a tubular projection extending upward from a bottom wall defining the recess and defining a longitudinal orifice in communication with the recess and further defining a transverse slot in the distal tip to communicate with the longitudinal orifice, a distal tip of the tubular projection being lower than the second step, and a bottom counter bore defined in the boss and in communication with the longitudinal orifice;
a porous filter for filtering the vapors of the battery and snugly received in the bore and resting on the second step;
a resilient cap mountable over the distal end of the tubular projection and extendable between a contracted state to prevent air entering from the atmosphere to the battery and an expanded state when the vapors are emitted from the battery, whereby the vapors can travel from the longitudinal orifice to the filter; and
a disc to protect the porous filter and snugly mountable in the top counter bore and rested on the first step, the disc defining an egress therethrough, and further defining a cavity in an under face thereof and in communication with the egress, the disc being removable when a tool is inserted in the notch of the top counter bore of the plug and urged against a side face of the disc,
wherein the vapors travel from the interior of the battery sequentially to the bottom counter bore, the longitudinal orifice, the resilient cap, the recess, the filter, and the cavity and egress of the disc to the atmosphere.
